(19) United States
(12) Patent Application Publication
(10) Pub. No.: US 2021/0156768 A1
(43) Pub. Date: May 27, 2021

(54) METHODS AND VIAL CLOSURES FOR HEADSPACE MICROEXTRACTION UNDER VACUUM

(71) Applicant: Eleftheria PSYLLAKI, Chania (GR)

(72) Inventor: Eleftheria PSYLLAKI, Chania (GR)

(21) Appl. No.: 17/100,070

(22) Filed: Nov. 20, 2020

Related U.S. Application Data
(60) Provisional application No. 62/939,359, filed on Nov. 22, 2019.

(51) Int. Cl. G01N 1/22; G01N 1/24

(52) U.S. Cl. CPC G01N 1/2226; G01N 2001/247; G01N 2001/2229; G01N 1/24

(57) ABSTRACT

A closure device for gas-tightly closing the opening of a vial which in use contains a liquid or solid material and sufficient headspace volume for performing off-line or automated headspace microextraction under vacuum conditions. The closure device allows for the air-evacuation of the sample container through a cavity with a seal in the presence or absence of the sample and maintains the low-pressure conditions for extended times and during handling of low or high-capacity extracting units. The methods are for off-line or automated headspace microextraction under vacuum conditions, so that the extracting unit with analytes can be conveniently analyzed by means of an analytical instrumentation such as gas chromatography, gas chromatography-mass spectrometry, liquid chromatography, and/or liquid chromatography-mass spectrometry.

### CROSS-REFERENCE TO RELATED APPLICATION

The present application claims benefit of priority to U.S. Provisional Application No. 62/939,359 filed Nov. 22, 2019, which is incorporated by reference herein in its entirety.

### BACKGROUND

### Field of the Invention

The present invention relates to headspace microextraction under vacuum and consists of devices and methods for use in manual or automated headspace microextraction using techniques such as solid phase microextraction (SPME), liquid phase microextraction (LPME) or techniques with higher capacity extracting phase, such as SPME Arrow, thin film microextraction (TFME) and stir bar sorptive extraction (SBSE) prior to chromatographic analysis, such as gas chromatography (GC) and liquid chromatography (LC), or mass spectrometric (MS) analysis.

### Description of the Related Art

Sample preparation is an essential part of chemical analyses such as GC and LC and refers to processes through which samples are handled and modified to make them amenable to a particular instrumental method of analysis. Extraction is an important sample preparation process and involves the isolation of analytes from a complex sample or much larger sample volume. The process is intended to provide a sample aliquot enriched with analytes that is relatively free of interferences and is compatible with the intended analytical method. Current demands in extraction analytical procedures include sensitivity, speed, selectivity, robustness, effectiveness, automation and low cost.

The extraction of analytes from liquid or solid samples employs a solid or liquid extracting phase to extract analytes present in the sample and after extraction the analytes contained in the extracting phase are thermally desorbed or eluted using a solvent before analysis by means of a chromatographic analytical instrumentation coupled to a variety of detectors or directly to a mass spectrometer. Depending on the amount of extracting phase used, the techniques are referred to as microextraction techniques and rely on the partition equilibrium between the different phases involved, or as exhaustive methods where analytes are exhaustively transferred from the sample to the extracting phase.

Microextraction methods are commonly categorized as solid- and liquid-phase based techniques depending on the type of extracting phase used. The most common commercially available solid-phase based technique is SPME that uses a thin fused silica fiber coated with a small amount of a polymeric film to extract analytes from a sample. TFME and SBSE are other methods of choice and consist of scaled-up versions of SPME that use a relatively higher volume of extracting phase and therefore have a higher analyte capacity compared to SPME. Although SBSE has a high opportunity to achieve exhaustive extraction opportunity to achieve exhaustive extraction, the method is not usually operated as an exhaustive extraction and the technique is treated as a microextraction method. Liquid-phase based techniques, generally known as solvent microextraction (SME) or liquid-phase microextraction (LPME) techniques, use as extracting phase a small volume of a liquid, such as an organic solvent. Single-drop microextraction was the first such reported method that used a water-immiscible organic solvent in the form of a microdrop to extract target analytes from the sample.

The two most basic extraction sampling modes are immersion and headspace. In the immersion sampling mode, the liquid or solid extracting phase is immersed into the sample and analytes are extracted directly from the sample matrix, whereas in the headspace sampling mode, the extracting phase is exposed to the headspace above the sample and the analytes need to be transported through the barrier of air before they can reach the extracting phase. This modification serves primarily to extract analytes from solid samples or to protect the extracting phase from hostile matrices and prevent interaction with matrix interferences.

In headspace microextraction, the time needed to reach equilibrium depends on the properties of the target analyte, matrix, and extracting phase. It is generally agreed that the headspace microextraction of volatile analytes occurs faster than that of semi-volatiles. This is because semi-volatiles must be transported through the gaseous barrier before reaching the extracting coating, but their low affinity for the gas-phase results in small extraction rates and long equilibration times. Relatively long equilibration times were also recorded even for analytes having a large affinity for the headspace provided that their affinity for the extracting phase is also high or that high capacity sorbents are used. This is because for these analytes, the large amounts to be extracted at equilibrium also require more time to approach this condition.

To reduce extraction times and improve sample throughput in analytical laboratories without affecting the sensitivity of the resulting analytical methods, different strategies are applied the most common being heating the sample during headspace microextraction. Despite its widespread use, this approach is not always efficient as it can result in sample decomposition and/or the creation of other components or artifacts. Moreover, in some cases, increasing the sampling temperature may decrease partitioning of target analytes and favor the gas phase over the extracting phase, thereby reducing extraction efficiencies and sensitivity.

An alternative approach to reduce equilibration times is to perform headspace sampling under reduced pressure conditions. Vacuum headspace microextraction sampling does not affect the final amount of analyte extracted at equilibrium, but greatly accelerates the extraction kinetics of analytes having long equilibration times under regular atmospheric pressure. Next to accelerating the kinetics of volatilization from the sample, applying vacuum conditions was also found to accelerate the step of analyte uptake by the extracting phase especially when a high capacity extracting phase is used. Compared to headspace microextraction methods under standard atmospheric pressure, headspace sampling under a low sampling pressure results in high extraction efficiencies and very good sensitivities within shorter sampling times and at lower sampling temperatures compared to extraction under regular atmospheric pressure. At the same time, headspace microextraction under vacuum was also found to result in a larger number of analytes extracted from complex samples compared to the standard methodology, which can be of particular importance during the untargeted analysis of complex samples.

Headspace sampling under vacuum was also used in a commercialized sample preparation method called vacuum-assisted sorbent extraction (VASE), which relies on the exhaustive extraction of analytes from samples rather than partition equilibrium between the phases involved as seen in the microextraction techniques described earlier. In VASE, a vacuum-controlled sorbent trap called sorbent pen, packed with a large quantity of extraction material (approximately 10 times the volume typically used for SBSE and approximately 500 times the volume typically used for SPME) is used for exhaustive extraction. VASE has several limitations, including that it can only be performed using the dedicated sorbent pens, the air evacuation of the sample container can only take place in the presence of the sample, and problems of water condensation in the cavity of the sorbent pen obstruct analysis.

There is a need for methods and gastight devices for headspace microextraction under vacuum from solid or liquid samples that can be used in combination with a large variety of existing off-line and automated headspace microextraction techniques prior to chemical analysis.

### BRIEF DESCRIPTION OF THE DRAWINGS

FIG. 1 shows the (i) top view, (ii) cross section and (iii) bottom view of the basic representation of the invention.

FIG. 2 shows (i) the cross-section configurations of the preferred parts to be used for assembling the sample container and (ii) the final gas-tight sample container and the SPME holder and fiber serving as an exemplary extraction device used during headspace microextraction under vacuum.

FIG. 3 shows (i) the cross-section of another possible representation of the basic invention and (ii) the final gas-tight sample container and the TFME unit serving as an exemplary extraction device used during headspace microextraction under vacuum.

### DETAILED DESCRIPTION

The present invention is related to headspace microextraction under vacuum and consists of methods and closure devices that fit to screw-top and crimp-top vials and allow gas-tight seal of the vials for extended waiting times and during operations such as headspace microextraction or air-evacuation of sample container. Headspace microextraction techniques, include but are not limited to SPME, LPME, TFME or SBSE.

In the following description, reference is made to the accompanying drawings, which form part hereof, and in which it is shown by way of illustration specific examples that can be practiced. It is to be understood that other examples can be used and changes on the devices or methods can be made without departing from the scope of the examples of the closure device and the related methods which is to perform headspace microextraction from samples under vacuum.

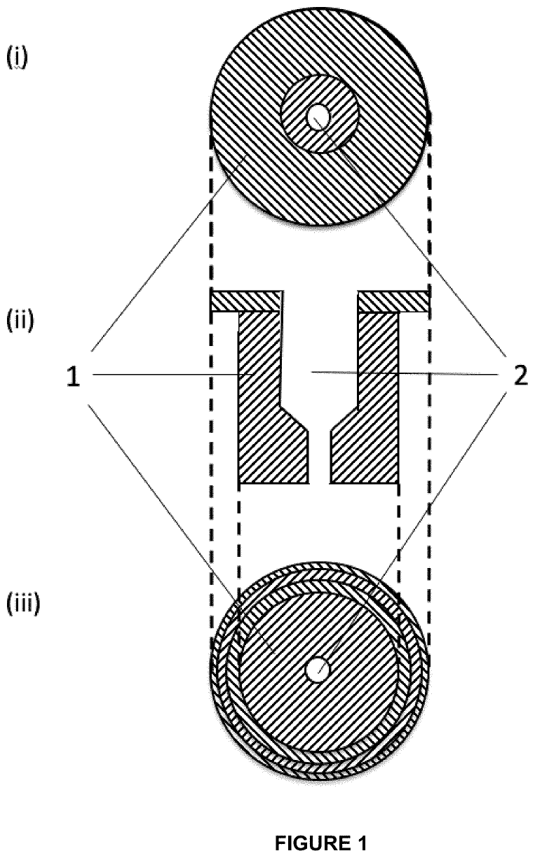

FIG. 1 shows different views of an exemplary embodiment of the invention where the device has a cylindrical body (1) and an aperture on its perpendicular axis (2) that can accommodate an internal seal. The main body of the device (1) is made of inert material such as stainless steel or polytetrafluoroethylene. In this configuration the top part of the aperture (2) has the shape of a hollow cap to tightly accommodate an internal seal. The closure device shown in FIG. 1 fits in the mouth of a vial and when equipped with an internal seal, offers gas-tightly closing to the opening of a vial. The internal seal can be a septum or a microvalve and allows substantial gas-tight seal of the aperture and has two functions that is to seal the aperture in a gas-tight manner while a slender object, such as a needle, is inserted and also while a slender object is not inserted. The septum should be reusable, such as for example the Thermogreen LB-1 septum, and the microvalve can be for example a merlin microseal. It is appreciated that configurations other than the one shown in FIG. 1 are possible, including an aperture having different dimensions that can accommodate a different size septum or microvalve. These modifications however, do not interfere with the basic concept of the device, which is to perform headspace microextraction under vacuum.

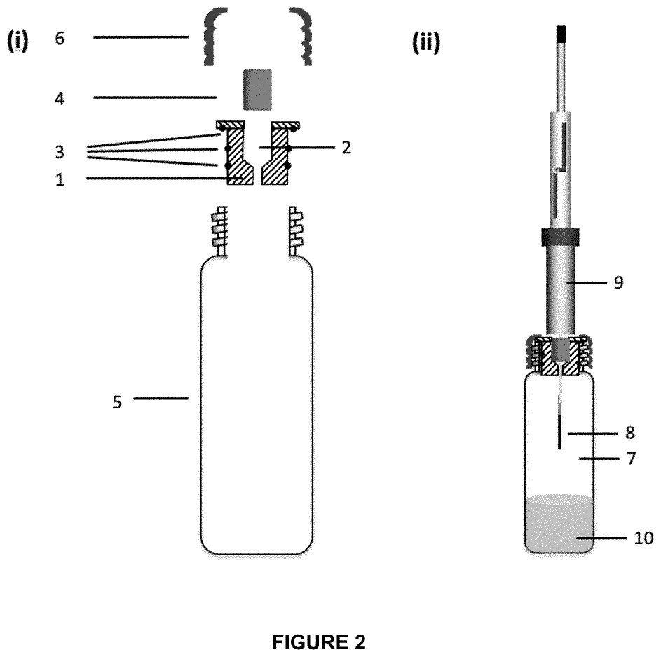

FIG. 2, shows (i) the cross-section configurations of the preferred parts to be used for assembling the sample container and (ii) the final gas-tight sample container together with an SPME holder and fiber, the latter representing as an exemplary extraction device used for headspace microextraction under vacuum. The closure device shown in FIG. 2(i) is that of FIG. 1 further modified on the outside of the main body (1) to accommodate external O-ring seals (3). The external seals can be fluoroelastomer or perfluoroelastomer seals. In this configuration, three external O-ring seals are used, but it is to be understood that the closure device can be modified to accommodate less or more external seals having different size or shape than the one shown here. The internal seal (4) is also shown in FIG. 2(i) and in this configuration, it consists of a septum. FIG. 2(i) also shows the commercial screw-thread vial (5) where the closure device is to be fitted and the magnetic cap with hole (6), which is optional for manual headspace microextraction but necessary when an autosampler that uses a magnet to move vials is to be used. The diameter of the hole of the cap must be larger than that of the aperture to allow operations through the internal seal. In FIG. 2(ii) showing the cross-section configuration of the final assembled gas-tight container the said sampling chamber (7) is also shown, inside which headspace microextraction under vacuum is performed. In this configuration, manual SPME is used for headspace microextraction under vacuum and FIG. 2(ii) depicts the manual SPME holder (9) for controlling the SPME fiber and the SPME fiber with extracting phase (8), which, in this configuration, is exposed to the headspace above a liquid sample (10).

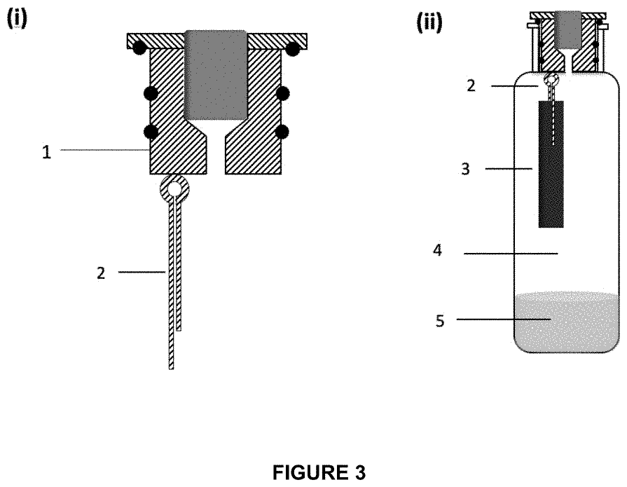

FIG. 3(i) shows another exemplary embodiment of the invention where the closure device shown in FIG. 2 is further modified to include a holder (2) attached to the bottom part of the main body (1) of the invention used to support extracting phase units. This configuration is intended for extracting phase units that do not have a holder for supporting them during headspace microextraction, such as TFME and SBSE. In the exemplary configuration shown in FIG. 3(i), the holder (2) consists of a stainless-steel cotter pin that is securely attached to the bottom part of the main body (1). FIG. 3(ii) shows the final assembled gas-tight container where the sampling chamber (7) contains a liquid sample (5), and a rectangular TFME unit (3) is secured in the cotter pin holder (2) in the headspace above the liquid sample (5). In this configuration a crimp top vial is used and the optional cap is not included since all operations are manual. It is appreciated that other configurations are possible. For example, a stainless-steel rod or clip can be used to hold the extracting phase unit. A stainless-steel rod that can also act as a support for larger volumes of extracting solvent in headspace solvent microextraction. In the case of SBSE, a magnet made of inert material can be attached to the main body (1) instead of the cotter pin (2) that can magnetically hold the SBSE unit. It is appreciated that for SBSE, other alternatives exist such as using the configuration of FIG. 2 and an external magnet to position the SBSE unit magnetically on the inner wall of a vial and above the sample.

Typical operation of headspace microextraction from liquid samples under vacuum using the device shown in FIG. 1 or 2 would involve fitting the closure device (1) equipped with an internal seal (4) and one or more external seals (3) when foreseen, to a sample vial (5). For manual off-line headspace microextraction under vacuum, capping the assembled gas-tight sample container with a cap with hole (6) is not necessary. The end of a vacuum line connected to a vacuum source is then inserted inside the sampling chamber (7) though the internal seal (4) and the air is evacuated. The vacuum line is then removed, while the vacuum is maintained inside the sample container, and the liquid sample (10) is poured in the sampling chamber (7) with the help of a gas-tight syringe through the internal seal (4). The properties of the liquid sample (for example ionic strength or pH) may be adjusted to desired values before introduction into the air-evacuated sampling container provided that the selected values enhance mass transfer into the headspace. The analytes present in the liquid sample (10) are then left for sufficient time to equilibrate with the headspace. This process may be accelerated with the use of any form of heating, agitation or a combination of the above. For magnetic stirring, an appropriate magnetic stir bar must be placed inside the sampling chamber (7) before air-evacuation. Upon sufficient sample equilibration an extraction device containing the extracting phase, such as the SPME holder (9) and fiber (8) shown in FIG. 2(ii), or a gas-tight micro-syringe containing a pre-set volume of an extracting solvent as extracting phase is then introduced into the sampling chamber (7) by piercing the internal seal, such as the septum (4) in FIG. 2, and the extracting phase is exposed to the air-evacuated headspace so that headspace microextraction under vacuum is performed for a period of time. The time needed for extraction will depend on many factors including the components to extract and the type of extraction method used. Typically, the present invention achieves enhanced recoveries for times shorter than the ones applied when performing conventional headspace microextraction under atmospheric pressure. Moreover, a larger number of analytes can be extracted from the sample compared to the standard methodology. Depending on the analytes to extract, any form of agitation, heating or a combination of the above will further improve headspace microextraction under vacuum. Depending on the sample type, heating is not necessary when sampling under vacuum. For example, when analysing perishable food, headspace microextraction under vacuum can proceed at temperatures below that of room temperature, such as the typical temperature of refrigerators, and the extraction efficiencies of analytes at this low sample temperature will be similar to those recorded at a higher sample temperature under regular atmospheric pressure conditions due to the beneficial effect of vacuum. Using a low sample temperature during headspace microextraction will exclude sample degradation due to heating, as reported under regular atmospheric pressure conditions, without affecting extraction recoveries. To avoid matrix-effect errors in quantitative analyses of complex samples several consecutive headspace microextractions under vacuum from the same sample are possible When headspace microextraction sampling under vacuum is completed, the extracting phase is retracted, removed from the sampling chamber (7) and transferred to a suitable analytical instrument for chemical analysis. The pressure inside the sampling chamber (7) is then equilibrated with the atmospheric pressure through the internal seal and after cleaning, the closure device may be used for the next extraction. The method described above using the device shown in FIG. 1 or 2 can be fully or partly automated when an autosampler having the option of headspace microextraction sampling using a solid or liquid extracting phase is coupled to the analytical instrumentation used for chemical analysis. The degree of automation depends on the additional options of the autosampler. When the autosampler only has the option of automated headspace microextraction, the air-evacuated sample vials fitted with the closure device with seals and capped with a magnetic cap having a hole diameter larger than the diameter of the aperture, are placed in the carousel of the autosampler and the autosampler performs all other operations. When the autosampler has the additional option of agitating the sample or controlling the sample temperature, either or both options are applied during headspace microextraction under vacuum. Depending on the application, the autosampler can perform several consecutive headspace microextractions under vacuum from the same sample. When the autosampler has the additional options of transferring liquid samples from one container to another and can also draw the vacuum from sample containers, then the assembled closure device equipped with seals, fitted to a vial and capped with a magnetic cap with a hole diameter larger than the diameter of the aperture is placed in the carousel of the autosampler. The autosampler then draws the vacuum, introduces the liquid, allows equilibration with the headspace and then performs headspace microextraction under vacuum for a period of time and then transfers the extracting phase to the coupled analytical instrumentation for chemical analysis. Depending on the application, the step of headspace microextraction under vacuum can be repeated several times from the same sample by the autosampler. When the autosampler has the additional option of agitating the sample or controlling the sample temperature, either or both options are applied during headspace microextraction under vacuum. In all cases described above that assume the use of an autosampler, when all samples in the sequence are analysed, the closure devices and vials containing the analyzed samples are removed from the carousel of the autosampler, the pressure inside the sampling chamber is equilibrated with the atmospheric pressure through the internal seal and after cleaning, the closure devices may be used for the next extraction.

For solid, slurry, and very viscous samples air-evacuation can only proceed in the presence of the sample. Air-evacuation in the presence of a liquid sample is also possible. A typical operation of headspace microextraction from solid or liquid samples under vacuum using the device shown in FIG. 1 or 2 would first involve placing a known amount of the sample in the vial. For solid samples, addition of water or water containing certain amounts of an organic solvent has been proven to facilitate the release of analytes from the solid matrix. The properties of a liquid sample (for example ionic strength or pH) may be adjusted to desired values before introduction into the vial provided that the selected values enhance mass transfer into the headspace. The closure device (1) equipped with an internal seal (4) and one or more external seals (3) when foreseen, is then fitted to a sample vial (5) containing the sample. For manual off-line headspace microextraction under vacuum capping the assembled gas-tight sample container with a cap with hole (6) is not necessary. The air is then removed by inserting the end of a vacuum line connected to a vacuum source inside the sampling chamber (7) through the internal seal (4). Removing the air in the presence of the sample should not affect the extraction of less volatile analytes but depending on the sample can lead to losses of the more volatile analytes due to aspiration. This drawback can be overcome if the time spend for air-evacuating the sample container is optimized and kept to a minimum. Moreover, lowering the temperature of the sample below that of room temperature before air-evacuation is another mean for minimizing analyte losses. For example, freezing the sample prior to air-evacuation will decrease analyte concentration in the headspace and minimize the portion of volatile analytes aspired during air-evacuation. Upon removing the air from the sample container, the analytes present in the solid or liquid sample are left to equilibrate for sufficient time with the headspace inside the sampling chamber (7). Depending on the application, this process has been reported to be further enhanced by applying any form of heating, agitation or a combination of the above. Upon sufficient sample equilibration an extraction device containing the extracting phase or a gas-tight micro-syringe containing a set volume of extracting solvent as extracting phase is then introduced into the sampling chamber (7) by piercing internal seal (4) and headspace microextraction is performed by exposing the extracting phase to the air-evacuated headspace. Depending on the analytes to extract, any form of agitation, heating or a combination of the above will further improve headspace microextraction under vacuum. Depending on the sample type, heating is not necessary when sampling under vacuum. For example, when analysing perishable food, headspace microextraction under vacuum can proceed at temperatures below that of room temperature, such as the typical temperature of refrigerators, and the extraction efficiencies of analytes at this low sample temperature will be similar to those recorded at a higher sample temperature under regular atmospheric pressure conditions due to the beneficial effect of vacuum. Using a low sample temperature during headspace microextraction will exclude sample degradation due to heating, as reported under regular atmospheric pressure conditions, without affecting extraction recoveries. To avoid matrix-effect errors in quantitative analyses of complex samples several consecutive headspace microextractions under vacuum from the same sample are possible. Once extraction is completed, the extracting phase is transferred in the analytical instrumentation for chemical analysis. The pressure inside the sampling chamber (7) is then equilibrated with the atmospheric pressure through the internal seal (4) and after cleaning, the closure device may be used for the next extraction. Typically, with the proposed method enhanced recoveries are obtained for shorter extraction times and lower sampling temperatures compared to the ones used for headspace microextraction under atmospheric pressure. Moreover, a larger number of analytes can be extracted from the sample compared to the standard methodology. This is the result of the positive effect of vacuum on the release of analytes from the sample matrix.

The method described above can be can be fully or partly automated when an autosampler having the option of headspace microextraction sampling using a solid or liquid extracting phase is coupled to the analytical instrumentation used for chemical analysis. The degree of automation depends on the additional options of the autosampler. When the autosampler only has the option of headspace microextraction, the air-evacuated sample vial containing the solid or liquid sample, fitted with the closure device with seals and capped with a magnetic cap having a hole diameter larger than the diameter of the aperture is placed in the carousel of the autosampler, and the autosampler performs headspace microextraction under vacuum for a period of time or, depending on the application, performs the extraction step multiple times from the same sample. When the autosampler has the additional option of drawing the vacuum from sample containers, then the assembled closure device equipped with seals, fitted to a vial containing the sample and capped with a magnetic cap with a hole diameter larger than the diameter of the aperture is placed in the carousel of the autosampler. The autosampler draws the vacuum at a controlled temperature, allows sufficient time for equilibration and then performs headspace microextraction under vacuum for a period of time or, depending on the application, repeats the extraction step under vacuum more than once from the same sample. In the cases described above, the sample temperature can be controlled at a temperature above or below room temperature, the sample can be agitated or a combination of the above depending on the options of the autosampler. Upon completion of the extraction, the autosampler transfers the extracting phase to the analytical instrumentation for chemical analysis. When all samples in the sequence are analysed, the assembled closure devices and vials containing the analyzed samples are removed from the carousel of the autosampler, the pressure inside the sampling chamber (7) is equilibrated with the atmospheric pressure through the internal seal (4) and after cleaning, the devices may be used for the next extraction.

Typical operation for the headspace microextraction of liquid and solid samples under vacuum using the device shown in FIG. 3 would involve placing a known amount of sample in the vial. The properties of a liquid sample (for example ionic strength or pH) may be adjusted to desired values before introduction into the vial provided that the selected values enhance mass transfer into the headspace. For solid samples, water or water containing certain amounts of an organic solvent has proven to be a very effective additive to facilitate the release of analytes from the solid matrix and it is often used to accelerate extraction. Then, an extraction unit such as a TFME or SBSE unit is attached to the holder such as the holder (1) shown in FIG. 3, of a closure device equipped with an internal seal and one or more external seals when foreseen and the whole is fitted to the sample vial containing the sample. Capping the assembled gas-tight sample container with a cap with hole is optional. The air is removed by inserting the end of a vacuum line connected to a vacuum source inside the sampling chamber (7) though the internal seal (4). Removing the air in the presence of the sample should not affect the extraction of less volatile analytes but depending on the sample it can lead to losses of the more volatile analytes due to aspiration. This drawback can be overcome if the time spend for air-evacuating the sample container is optimized and kept to a minimum. Lowering the sample temperature is another mean for minimizing analyte losses. For example, setting a low temperature for the sample before air-evacuation will decrease analyte concentration in the headspace and minimize the portion of volatile analytes aspired during air-evacuation. Upon removing the air from the gas-tight sample container, the extracting phase is left to extract the headspace under vacuum for a period of time. Depending on the sample type and analyte to extract, any form of agitation, controlling the temperature or a combination of the above can be applied during the extraction step. Depending on the sample type, heating is not necessary when sampling under vacuum. For example, when analysing perishable food, headspace microextraction under vacuum can proceed at temperatures below room temperature such the typical temperature of refrigerators and the extraction efficiencies of analytes at this temperature will be similar to those recorded at a higher sample temperature under regular atmospheric pressure conditions without affecting extraction recoveries and sensitivity. In the method described using the configuration shown in FIG. 3, higher capacity extracting phases are typically used. Headspace microextraction under vacuum may therefore have a positive effect on the volatilization of analytes as well as on the analyte uptake by the extracting phase. When headspace microextraction under vacuum is completed, the sampling chamber is equilibrated with the atmospheric pressure, the closure device is removed and the extracting phase is transferred for thermal or liquid desorption followed by analysis using a suitable analytical instrument for chemical analysis. After cleaning, the closure device may be used for the next extraction. The methods described above involving extraction units such as TFME and SBSE, that do not have holders for manipulation, are typically not automated. Instead, a number of samples are extracted offline under vacuum and in parallel, maximizing thus sample throughput.

1. A closure device for gas-tightly closing the opening of a vial which in use contains a liquid or solid material and sufficient headspace volume for performing headspace microextraction, said closure device comprising of a cylindrical body locatable in the mouth of a vial, having an aperture on its perpendicular axis that can accommodate an internal seal including a septum or a microvalve for making a substantial gas-tight seal to the aperture and through which the needle of a syringe or an extraction device containing an extracting phase may be inserted without affecting the pressure inside the said sampling chamber.

2. The device of claim 1, further modified to comprise one or more external seals positioned around the outer part of the closure device that provide additional gas-tight seal between the closure device and the vial.

3. The device of claim 1, further comprising a holder that is used for positioning an extracting phase in the inner part of the sampling chamber.

4. A headspace microextraction method under vacuum conditions using the closure device of claim 1, the method comprising: coupling the closure device equipped with an internal seal to a sample vial; drawing a vacuum for a period of time by inserting inside the sampling chamber and through the internal seal the end of a vacuum line connected to a vacuum source; removing the vacuum line after the vacuum is draw while the vacuum is held inside the sampling chamber; introducing the liquid sample with a gastight syringe in the sampling chamber and through the internal seal; remove the gastight syringe while the vacuum is held inside the sampling chamber; allow sufficient time for equilibration between the sample and headspace; inserting an extraction device through the internal seal of the closure device and exposing the liquid or solid extracting phase to the headspace above the sample for a period of time while the vacuum is held inside the sampling chamber; removing the extraction device and transferring it to an analytical instrumentation for chemical analysis; pressure equilibration between the device and the atmosphere through the internal seal.

5. A headspace microextraction method under vacuum conditions using the closure device of claim 1, the method comprising: placing an amount of the solid or liquid sample inside a vial; coupling the closure device equipped with an internal seal to the vial containing the sample; drawing a vacuum for a period of time by inserting inside the sampling chamber and through the internal seal the end of a vacuum line connected to a vacuum source; removing the vacuum line after the vacuum is draw while the vacuum is held inside the sample container; inserting an extraction device through the internal seal of the closure device and exposing the liquid or solid extracting phase to the headspace above the sample for a period of time while the vacuum is held inside the sampling chamber; removing the extraction device and transferring it to an analytical instrumentation for chemical analysis; pressure equilibration between the device and the atmosphere through the internal seal.

6. A headspace microextraction method under vacuum conditions using the closure device of claim 3, the method comprising: placing an amount of the solid or liquid sample inside a vial; securing an extraction device having a liquid or solid extracting phase at the holder; coupling the closure device equipped with an internal seal to the vial containing the sample; drawing a vacuum by inserting the end of a vacuum line connected to a vacuum source through the internal seal inside the sampling chamber; removing the vacuum line after the vacuum is draw while the vacuum is held inside the sample container; allow extraction for a period of time while the vacuum is held inside the sampling chamber; pressure equilibration between the device and the atmosphere through the internal seal; removing the extraction device and transferring it to an analytical instrumentation for chemical analysis.

7. The method of claim 4, wherein after the step of introducing the liquid sample, the air-evacuated sample container containing the sample further capped with a magnetic cap on top, are placed in an auto-sampler connected to an analytical instrumentation for chemical analysis and the auto-sampler performs all other operations.

8. The method of claim 4, wherein after the first step of assembling the sample container and before air-evaluation, the closure device equipped with an internal seal is fitted to a vial and further capped with a magnetic cap on top are placed in an auto-sampler connected to analytical instrumentation for chemical analysis, and the auto-sampler performs all operations.

9. The method of claim 5, where after the step drawing a vacuum, the closure device equipped with an internal seal, fitted to a vial containing the sample and further capped with a magnetic cap are placed in an auto-sampler connected to analytical instrumentation for chemical analysis, and the auto-sampler performs all other operations.

10. The method of claim 5, wherein before the step of drawing a vacuum, the closure device equipped with an internal seal, fitted to a vial containing the sample and further capped with a magnetic cap on top are placed in an auto-sampler connected to analytical instrumentation for chemical analysis, and the auto-sampler performs all other operations.

11. The method of claim 5, wherein before drawing a vacuum, the sample vial containing the sample is at a temperature below that of room temperature.

12. The method of claim 4, wherein the step of headspace microextraction under vacuum form the same sample is repeated more than once.

13. The method of claim 4, wherein headspace microextraction under vacuum is further coupled to any form of agitation, controlling the temperature above or below room temperature, or a combination of the above.
